(19) United States
(12) Patent Application Publication
(10) Pub. No.: US 2020/0219399 A1
(43) Pub. Date: Jul. 9, 2020

(54) LANE LEVEL POSITIONING BASED ON NEURAL NETWORKS

(71) Applicant: Visteon Global Technologies, Inc., Van Buren Township, MI (US)

(72) Inventors: Martin PFEIFLE, Seewald (DE); Hendrik BOCK, Zeiskam (DE); Vijay Jayant NADKAMI, San Jose, CA (US)

(21) Appl. No.: 16/734,862

(22) Filed: Jan. 6, 2020

Related U.S. Application Data
(60) Provisional application No. 62/788,635, filed on Jan. 4, 2019.

(51) Int. Cl. G08G 1/16; G01S 19/42; G01S 19/31; G06K 9/00; G06N 3/02

(52) U.S. Cl. CPC G08G 1/167; G01S 19/42; G06N 3/02; G06K 9/00798; G01S 19/31

(57) ABSTRACT

A method for position lane leveling includes: determining vehicle position information for a vehicle; determining lane position information for the vehicle based on output of a convolutional neural network; determining at least one of a road, a link, and a lane of the vehicle based on the vehicle position information and the lane position information; and controlling the vehicle based on the determined at least one of the road, the link, and the lane of the vehicle.

### CROSS-REFERENCES TO RELATED APPLICATIONS

This patent application claims priority to U.S. Provisional Patent Application Ser. No. 62/788,635, filed Jan. 4, 2019, which is incorporated herein by reference in its entirety.

### FIELD

Various navigation systems may benefit from suitable positioning methods and systems. For example, certain vehicle navigation and autonomous driving applications may benefit from lane level positioning based on neural networks.

### RELATED ART

Current navigation systems for automobiles are typically global positioning system (GPS) based. These systems use GPS technologies to detect an exact location. Based on that exact location information, the systems typically attempt to determine the road on which a vehicle travels.

In some cases, the system may attempt to use GPS data to further determine a particular direction of travel on a road, which may suggest a particular lane in the case of two-lane roads. While this technology may be useful for some applications, the level of accuracy of commercial GPS may make lane determination based solely on GPS difficult to use for situations in which the vehicle should know the actual lane of travel.

Modern navigation systems as well as highly automated driving applications heavily rely on accurate positioning and map matching. These applications rely on knowing exactly where the car is located in an absolute world-wide coordinate system. Based on this information, it is possible to map the car to a position in the digital map for guidance purposes.

The first thing that happens in a locally operated navigation system is that the car is positioned on a digital map that is stored inside the vehicle. In order to do this, Global Navigation Satellite System (GNSS) information, for example from GPS, Galileo or the like, is used. Based on such satellite information it is possible to compute the current car position (CCP) in a world-wide coordinate system. Typically, the CCP is expressed by a longitudinal and latitudinal position within World Geodetic System (WGS 84). The navigation system then maps this global position to a link of a digital map. Digital maps are often organized spatially, for example in tiles, so that the navigation system can quickly map a global GNSS position to the corresponding link in a navigational database.

If the user enters a destination, for instance via Full Text Search (FTS), the navigation system can find a destination link and compute the route from the CCP-link to the destination link. The computed route is expressed as a sequence of links. During the journey, the navigation system constantly aligns the GNSS information to the digital map information. This constant mapping enables the system to give guidance advice, such as “turn left in 100 meters,” if the car approaches an intersection. Thus, navigation systems use GNSS information for Map Matching (at the link level), which can then be used for Guidance (at the link level).

The positions derived from GNSS signals can be imprecise. For example, the GNSS signal might indicate a latitude/longitude-value that is more than 20 meters from a current actual position. This is especially true in very hilly areas or for roads surrounded by high-rise buildings.

### SUMMARY

An aspect of the disclosed embodiments includes a method that includes: determining vehicle position information for a vehicle; determining lane position information for the vehicle based on output of a convolutional neural network; determining at least one of a road, a link, and a lane of the vehicle based on the vehicle position information and the lane position information; and controlling the vehicle based on the determined at least one of the road, the link, and the lane of the vehicle.

Another aspect of the disclosed embodiments includes a system that includes a processor and a memory. The memory includes instructions that, when executed by the processor, cause the processor to: determine vehicle position information for a vehicle; determine lane position information for the vehicle based on output of a convolutional neural network; identify at least one of a road, a link, and a lane of the vehicle based on the vehicle position information and the lane position information; and control the vehicle based on the determined at least one of the road, the link, and the lane of the vehicle.

Another aspect of the disclosed embodiments includes a system for vehicle position lane leveling. The system includes a processor and a memory. The memory includes instructions that, when executed by the processor, cause the processor to: receive vehicle position information; receive output from a convolutional neural network, the output being based on image data provided to the convolutional neural network; determine lane position information for a vehicle based on the output of the convolutional neural network; identify at least one a lane associated with the vehicle based on the vehicle position information and the lane position information; and control the vehicle using the identified lane.

### BRIEF DESCRIPTION OF THE DRAWINGS

The accompanying drawings are provided for purposes of illustration and not by way of limitation.

FIG. 1 generally illustrates a vehicle according to the principles of the present disclosure.

FIG. 2 generally illustrates a method according the principles of the present disclosure.

FIG. 3 generally illustrates a system according to the principles of the present disclosure.

FIG. 4 generally illustrates an alternative method according to the principles of the present disclosure.

### DETAILED DESCRIPTION

The following discussion is directed to various embodiments. Although one or more of these embodiments may be preferred, the embodiments disclosed should not be interpreted, or otherwise used, as limiting the scope of the disclosure. In addition, one skilled in the art will understand that the following description has broad application, and the discussion of any embodiment is meant only to be exemplary of that embodiment, and not intended to intimate that the scope of the disclosure is limited to that embodiment.

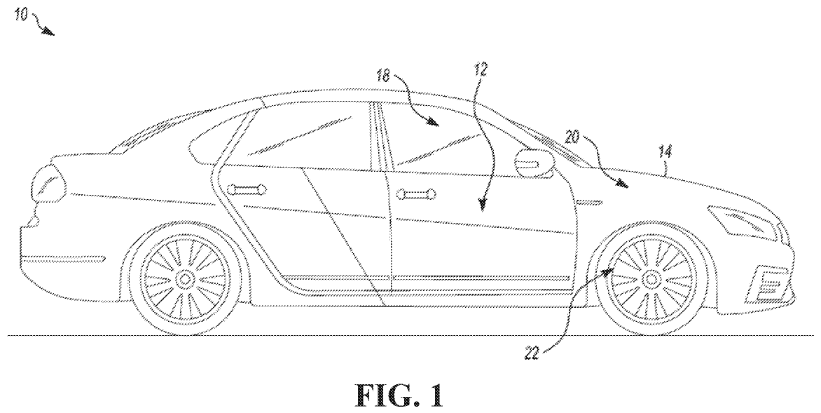

FIG. 1 generally illustrates a vehicle 10 according to the principles of the present disclosure. The vehicle 10 may include any suitable vehicle, such as a car, a truck, a sport utility vehicle, a mini-van, a crossover, any other passenger vehicle, any suitable commercial vehicle, or any other suitable vehicle. While the vehicle 10 is illustrated as a passenger vehicle having wheels and for use on roads, the principles of the present disclosure may apply to other vehicles, such as planes, boats, trains, drones, or other suitable vehicles.

The vehicle 10 includes a vehicle body 12. The vehicle 10 may include any suitable propulsion system including an internal combustion engine, one or more electric motors (e.g., an electric vehicle), one or more fuel cells, a hybrid (e.g., a hybrid vehicle) propulsion system comprising a combination of an internal combustion engine, one or more electric motors, and/or any other suitable propulsion system.

In the context of driving automation, the vehicle 10 may be a semi-automated or a fully automated. Under semi-automated driving automation, the vehicle 10 may perform automated driving operations which may be supervised by an operator or other occupant of the vehicle 10 or may be limited in nature, such as park assist. Under fully automated driving automation, the vehicle 10 may perform automated driving operations which may be unsupervised by an operator or other occupant of the vehicle 10 and may be independent in nature, such as complete navigation from point A to point B without supervision or control by the operator or other occupant.

The vehicle 10 may include any suitable level of driving automation, such as defined by the society of automotive engineers (e.g., SAE J3016). For example, the vehicle 10 may include features of level 0 automation, level 1 automation, or level 2 automation. For example, the vehicle 10 may include one or more features that assist an operator of the vehicle 10, while requiring the operator of the vehicle 10 to drive the vehicle 10 or at least supervise the operation of the one or more features. Such features may include cruise control, adaptive cruise control, automatic emergency braking, blind spot warning indicators, lane departure warning indicators, lane centering, other suitable features, or a combination thereof.

In some embodiments, the vehicle 10 may include features of level 3 automation, level 4 automation, or level 5 automation. For example, the vehicle 10 may include one or more features that control driving operations of the vehicle 10, without operator or other occupant interaction or supervision of the one or more features by the operator or other occupant. Such features may include a traffic jam chauffeur, limited scenario driverless features (e.g., features that allow the vehicle 10 to operate autonomously, without operator or other occupant interaction or supervision, in specific situations, such as specific route, or other specific situations), fully autonomous driving features (e.g., features that allow the vehicle 10 to drive completely autonomously in every scenario, without operator or other occupant interaction or supervision), or other suitable features. The vehicle 10 may include additional or fewer features than those generally illustrated and/or disclosed herein.

As discussed previously, the conventional driver assist systems provide the driver with information that is relevant to a particular driving situation along with a lot of other information that may not be irrelevant to that particular driving situation. This is because the conventional systems do not take into account the cognitive load that is on the driver in a particular driving situation, while the driver has to navigate thru the plethora of information bits provided by the conventional systems to get the relevant information.

In some embodiments, a method can include determining global positioning system information for a vehicle, such as the vehicle 10. The global positioning system information can include at least one of GPS, GNSS, differentially corrected GPS, or differentially corrected GNSS.

The method can also include determining lane position information for the vehicle 10 based on output of a convolutional neural network. The lane position information can include a lane number, a total number of lanes, a type of lane, current position within a current lane, an indication of drivable space within a current lane, or the like, individually or in any combination. The output of the convolutional neural network can be based on image data received as image capturing device input (e.g., camera input).

The method can further include determining a road, link, and lane of the vehicle 10 based on combining the global positioning system information and the lane position information.

The method can additionally include controlling or communicating with the vehicle 10 based on the determined road, link, and lane of the vehicle 10.

Some embodiments of the present disclosure may permit a lane determination that is robust enough for autonomous vehicles/driving conditions. More particularly, some embodiments relate to employing a camera detecting an environment, using the images along with neural networks, and detecting a lane based on the above. Some embodiments may involve employing a front facing camera for lane detection. Furthermore, some embodiments may further involve employing neural networks for lane detection.

Some embodiments may assist navigation systems and navigation maps to allow for lane-level positioning and guidance in addition to link-based positioning and guidance. Modern high definition (HD) maps can include, in addition to topological and geometrical information related to links, similar information related to lanes. The lane information typically consists of (1) lane connectivity, (2) lane center line geometry, (3) lane boundary geometry and (4) various lane-specific attributes, e.g. speed limits and traffic restrictions.

Based on such HD databases and very precise GNSS signals, it is possible for the navigation systems to locate the car on a lane within a link. Based on such lane-level positions and the lane topological information within an HD map, the navigation systems can considerably improve their guidance announcements. For instance, if the system knows that the car needs to turn right in 700 meters and it is located on the leftmost lane of a highway, the system can utter provide announcements, such as change to the right lane. On the other hand, if the car already is on the rightmost lane, such announcement can be omitted. Both voice and visual lane guidance may rely on HD maps and very precise GNSS information.

Modern highly automated driving (HAD) applications use exact lane positions as well. In order to get from A to B, these applications may need to change a vehicle, such as the vehicle 10, from the leftmost lane to the rightmost lane, for example in order to take a particular exit.

Nevertheless, some embodiments permit the use of one or more cameras or similar sensors to assist the HAD application in determining the exact lane position, even with less precise GNSS signals.

Based on an uncertain GNSS signal and digital map information indicating that a given link has 3 lanes, it may be possible to derive a probability value for being located on each of the lanes. In a specific example, there may be a 40 percent probability of being in a left lane, a 34 percent probability of being in a center lane, and a 26 percent probability of being in a right lane. The system may rule out the possibility that the vehicle 10 is on the wrong side of the road, driving on a shoulder of the road, or driving off road.

These probabilities per lane may be based on the geometry of the lanes provided by the digital map, together with the reported GNSS position and a two sigma error distribution with respect to the reported position.

In addition, the car may be positioned not solely based on one measurement, but based on a sequence of measurements. This sequence of measurements may make error in the GNSS position more identifiable. Other sensor data can also be used, such as the speedometer of the vehicle 10, to validate that the GNSS position is approximately correct. In some embodiments, the procedure can be to measure the position of the car, predict the new position based on the car's movement information, measure again and then merge the prediction with the new measurement, for example using a Kalman filter. For lane level positioning, the uncertainty of the GNSS signals may still be too high to determine which of the three lanes contains the vehicle 10. Thus, some embodiments may supplement the GNSS position with additional sensor data, such as camera sensor data or the like (for example, LiDAR, ultrasonic, and so on).

Many ADAS applications, for example lane departure warning or highway chauffeur, may depend on an accurate detection of the lane markings left and right of the car. The result of such a lane marking detection algorithm may be a region of interest that includes a current lane and an area to the left and right of the lane. In order to detect the lane markings, algorithms from computer vision (such as Canny or Hough transform algorithms) can be used. In addition, the search space can be reduced in order to increase the performance and accuracy of the algorithm.

As a result of these algorithms, lane borderline information relative to the current car position can be derived. This borderline information may be useful for the support of ADAS functionality. It may be possible to compute functions describing the lane geometry in a coordinate system of the car. Consequently, it may also be possible to derive the current car position relative to the left and right lane boundary and the center line of the lane, which can be used for controlling the car's further movement.

Some embodiments may employ the output of lane borderline detection to assist in lane level positioning. Alternatively, some embodiments may employ a different analysis of the same sensor data used for lane borderline detection to make a different determination regarding lane level positioning.

Modern self-driving cars may rely on machine-learning algorithms, including convolutional neural networks (CNNs). CNNs can be used for classifying/detecting cars, pedestrians, bicycles, traffic signs, and the like.

In addition to mere classification, it is also possible to use neural networks for determining the bounding boxes around objects. This process is often called regression. For example, some CNNs can be trained to do both object classification and object localization. Parts of the architecture can be shared and parts can be specific to object classification and to object localization, which can also be referred to as regression. This technique can be referred to as RCNN, from Regions and CNN. RCNNs can be used for detecting various road objects and their spatial positions and extensions. In some embodiments, RCNNs can be used for map matching and positioning, such as mapping the car to a lane of a digital map.

The approaches described above can have a car-centric coordinate system. The world can be perceived as having the car in the center of the coordinate system. For instance, it is possible to detect lane markings with OpenCV techniques. The resulting lane information might be represented as a straight or curved line with respect to the car. This ego-centric view may be useful for controlling the car. For example, this information provided in this way may be useful for keeping the car in the middle of the two detected lane markings. On the other hand, a world-centric view (such as an electronic horizon or ehorizon view) can be used to support finding a route path to follow and to process information from services, such as messages providing detail like “construction work on the 3rd lane on northbound highway 95 near mile marker 25.”

Some embodiments use neural networks for determining in which lane of a road the car is located. This can be done based on a CNN that processes images and returns a lane number for each image.

The CNN can be trained using images and label information. An image may be labeled with a class ID 01, representing that the car is on lane number one, or with a class ID 0102, representing that the car is on lane number one of a road consisting of 2 lanes. The same labels might be used for multiple images taken at different times of day and on different roads, but in similar situations using the same numbering convention (for example, lane one may be the left-most lane). Note that the CNN may detect the correct lane number not only based on lane markings, but also based on cars/trucks moving parallel to each other. The training data for the CNN may contain many different examples for each class, so that the CNN can correctly detect the right lane number.

Various lane situations can be variously encoded. For example, if an image shows a car traveling in the leftmost lane of a three-lane link, the image may be coded as class ID 01 in a simple lane classification system or class ID 0103 in a system that also expresses a total number of lanes.

If the ID system also allows for distinguishing between exit lanes and normal lanes, the ID of a given lane might be, for example, 0202ER01, indicating that the car is on lane number 2 out of two lanes and that there is one exit lane to the right. Similarly, other conditions of the lane may be encoded.

Other lane conditions can be temporary conditions, such as electronically restricted lanes (lanes with a red X over the lane on a road with such signage), lane with a high occupancy vehicle (HOV) or similar restriction, lane with passing permitted or prohibited (which may be indicated by a dotted line, solid line, solid double line, or the like), or lane with an environmental condition. The environmental condition may be that the lane has snow, ice, mud, or other debris on the road surface, or a pothole or other gap in the road surface. The lane condition may also specify the construction of the road, for example, concrete, asphalt, dirt, gravel, or board. Other data may also be encoded.

The lane condition information may also include other information, such as approximate shoulder width, the presence or absence of barriers, such as metal or concrete barriers, orange cones, barrels, or the like.

Optionally, the lane condition information may also include the presence or absence of other vehicle, including generally whether the lane has other traffic, a specific kind of other traffic (for example, trucks, cars, emergency vehicles, farm vehicles, or the like), or even specific models or license plate numbers of vehicles.

In some embodiments, the CNN may be used for detecting simply a lane number in which the car is currently located. The CNN might return only a lane number, or a lane number along with the overall number of lanes.

The training data may allow the CNN to learn the current lane number for all day and weather conditions and for all traffic situations, even when cars are moving parallel to each other and no lane marking is available. This latter condition may exist when the camera is unable to see lane markings, such as in certain fog situations, snow conditions, rain conditions, or even when a road is unmarked (for example, due to heavy wear or recent paving).

As mentioned above, the GNSS signal can be rather inaccurate. The GNSS signal may allow determination of the link the car is travelling on, but not of the lane. The positional uncertainty can be reduced significantly using a CNN. If the CNN provides the information that the car is located on lane number 1. Then the system can derive the lane geometry from the digital map, integrate, and normalize the GNSS signal over the lane geometry. The lane position determination techniques used for highway chauffer or lane departure can augment this lane position information to provide an even more precision positioning of the vehicle 10 with respect to the center of an identified lane. This may reduce the uncertainty of the GNSS signal to the position in the direction of the lane. Other sensors, such as accelerometers, can be used to help reduce the uncertainty in the direction of travel along the lane.

Sometimes the GNSS signal is so inaccurate that it is difficult to detect on which road the car is currently traveling. For example, some highways have parallel service or frontage roads that are within 20 meters of the highway lanes. GNSS may not be able to reliably distinguish between the highway and the parallel road.

Nevertheless, if the output of the CNN provides information that the car is on a one lane road, then this information can be used to assist link identification by indicating that the frontage road rather than the highway is the current road for the vehicle 10. Similarly, if the CNN indicates that the road is a three lane road, then the link identification can correctly identify that the link is the highway.

As another alternative, rather than simply identifying a lane number or a lane number and a total number of lanes, an RCNN can be used to provide an overall width of a given lane or road and a current latitudinal position within the given lane or road. This may similarly help to distinguish between links when the links have different lane widths. For example, highway lanes may be wider than frontage lanes. Likewise, the highway may have a much larger road width than the frontage road.

In this approach, images for training can be labelled with one number for overall road width and another number for current position within the available road width. The RCNN can learn these two parameters independently of any lane number information. Thus, for example, instead of labelling an image with left lane out of two lanes, the image may be labeled as 2.8 meters from the left with 7.4 meters available. In another example, instead of the middle lane of three lanes, the image may be labelled as having 9.6 meters of drivable space with a current position of 6.9 meters. Other conventions for labelling are also permitted.

In some embodiments, both approaches outlined above can be performed in real time in parallel processors. Thus, for example, a first process can compute a lane number out of a total number of lanes from an image or series of images and a second process can computer a current road position and road width from the same set of images. The road width and position information can be used to determine a particular lane with reference to a digital map. The two results can then be compared to gain confidence regarding an actual position.

Using the RCNN approach above may provide for a different kind of correlation during a lane change maneuver. For example, the parameter for road width may be roughly the same across a series of images even though the road position may gradually change. Similarly, the total number of lanes may remain constant even though the current lane may change in a discrete manner.

In addition to latitudinal positioning, the information provided by the RCNN might also help with more precise longitudinal positioning. Assume there are changes in the width of the drivable space, for example when lanes form or end. In these situations, the RCNN in the car might provide a changing width of the drivable space for every frame. The system can now use this information along with the information provided from the digital map for precise longitudinal positioning. Similarly, when a number of total lanes increases, that information may help to provide some longitudinal positioning information to the system.

Accordingly, some embodiments can use neural networks for map matching and positioning. Thus, some embodiments may enhance navigation systems and highly automated driving applications. Some embodiments can improve latitudinal positioning, and even longitudinal positioning.

Some embodiments can use CNNs for lane level positioning. The process can involve labelling training images with lane number where the car is located. The process can further involve labelling training images with overall lane number of the road the car is occupying. The process can additionally involve classifying, at runtime, camera images or other sensor data and returning the lane number the car is occupying and the overall number of lanes. The process can also include combining the classification information with digital map information to retrieve global lane-level positioning with respect to the digital map. Furthermore, the process can include using the classification information for link-level positioning in ambiguous situations.

Some embodiments likewise can use RCNNs. In some embodiments, a process can include labelling training images with width of drivable space W and current latitudinal position P within the free space (0<P<W holds). A process can also include combining at runtime the information provided by the RCNN and a digital map to determine a global lane-level position with respect to a current digital map. The process can further include using the information provided by the RCNN for detecting lane changes, for example when P changes and W is constant. The process can additionally include using the information provided by the RCNN for longitudinal positioning, for example, when W changes.

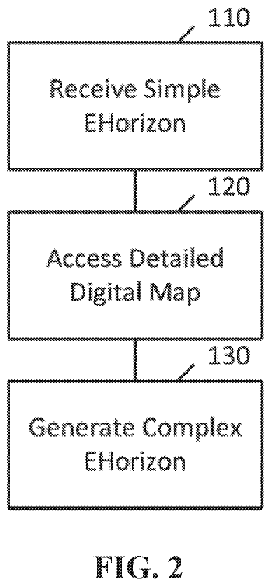

FIG. 2 illustrates a method according to some embodiments. As shown in FIG. 2, a method can include, at 110, determining global positioning system information for a vehicle, such as the vehicle 10. The global positioning system information can include GPS, GNSS, differentially corrected GPS, differentially corrected GNSS, or any similar information.

The method can also include, at 120, determining lane position information for the vehicle 10 based on output of a convolutional neural network. The lane position information can include a lane number. Optionally, the lane position information can also include a total number of lanes. The lane position information comprises a type of lane.

The position information can include a current position within a current lane and an indication of drivable space within a current lane. Moreover, the position information can also or alternatively include a current position within a current link or road and an indication of drivable space within a current link or road.

The method can further include, at 130, determining a road, link, and lane of the vehicle 10 based on combining the global positioning system information and the lane position information. The method can additionally include, at 140, controlling or communicating with the vehicle 10 based on the determined road, link, and lane of the vehicle 10. The output of the convolutional neural network can be based on camera input, such as an image or series of images.

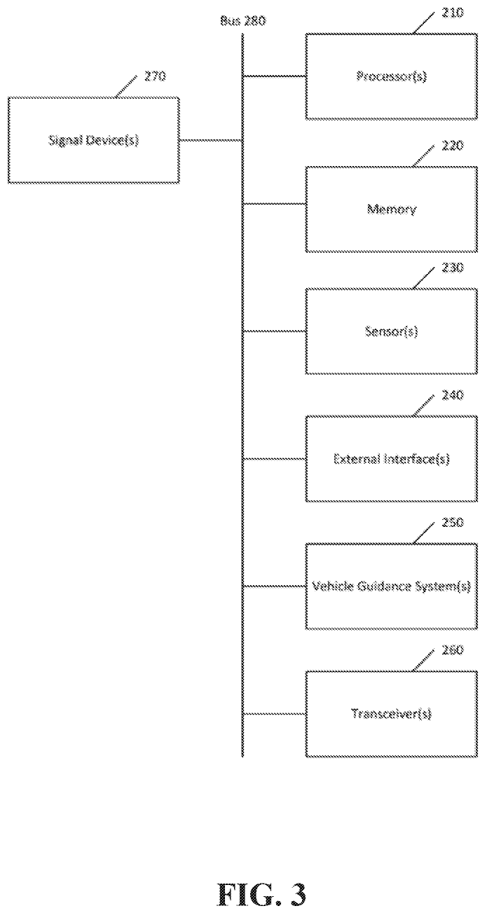

FIG. 3 illustrates a system according to some embodiments. The system illustrated in FIG. 3 may be embodied in a vehicle, such as the vehicle 10 or in one or more components of the vehicle 10. For example, some embodiments may be implemented as an electronic control unit (ECU) of the vehicle 10.

The system can include one or more processors 210 and one or more memories 220. The processor 210 and memory 220 can be embodied on a same chip, on different chips, or otherwise separate or integrated with one another. The memory 220 can be a non-transitory computer-readable memory. The memory 220 can contain a set of computer instructions, such as a computer program. The computer instructions, when executed by the processor 210, can perform a process, such as the method shown in FIG. 2, or any of the other methods disclosed herein.

The processor 210 may be one or more computer chips including one or more processing cores. The processor 210 may be an application specific integrated circuit (ASIC) or a field programmable gate array (FPGA). The memory 220 can be a random access memory (RAM) or a read only memory (ROM). The memory 220 can be a magnetic medium, an optical medium, or any other medium.

The system can also include one or more sensors 230. The sensors 230 can include devices that monitor the position of the vehicle 10 or surrounding vehicles. Devices can include, for example, global positioning system (GPS) or the like. The sensors 230 can include cameras (visible or infrared), LiDAR, ultrasonic sensors, or the like.

The system can also include one or more external interfaces 240. The external interface 240 can be a wired or wireless connection to a device that is not itself a component of the vehicle 10. Such devices may include, for example, smart phones, smart watches, personal digital assistants, smart pedometers, fitness wearable devices, smart medical devices, or any other portable or wearable electronics.

The system can also include one or more vehicle guidance systems 250. The vehicle guidance system 250 may include its own sensors, interfaces, and communication hardware. For example, the vehicle guidance system 250 may be configured to permit fully autonomous, semi-autonomous, and manual driving. The vehicle guidance system 250 may be able to assume steering control, throttle control, traction control, braking control, and other control from a human driver. The vehicle guidance system 250 may be configured to operate in conjunction with an advanced driver awareness system, which can have features such as automatic lighting, adaptive cruise control and collision avoidance, pedestrian crash avoidance mitigation (PCAM), satnav/traffic warnings, lane departure warnings, automatic lane centering, automatic braking, and blind-spot mitigation.

The system can further include one or more transceivers 260. The transceiver 260 can be a WiFi transceiver, a V2X transceiver, or any other kind of wireless transceiver, such as a satellite or cellular communications transceiver.

The system can further include signal devices 270. The signal device 270 may be configured to provide an audible warning (such as a siren or honking noise) or a visual warning (such as flashing or strobing lights). The signal device 270 may be provided by a horn and/or headlights and taillights of the vehicle 10. Other signals are also permitted.

The signal device 270, transceiver 260, vehicle guidance system 250, external interface 240, sensor 230, memory 220, and processor 210 may be variously communicably connected, such as via a bus 280, as shown in FIG. 3. Other topologies are permitted. For example, the use of a Controller Area Network (CAN) is permitted.

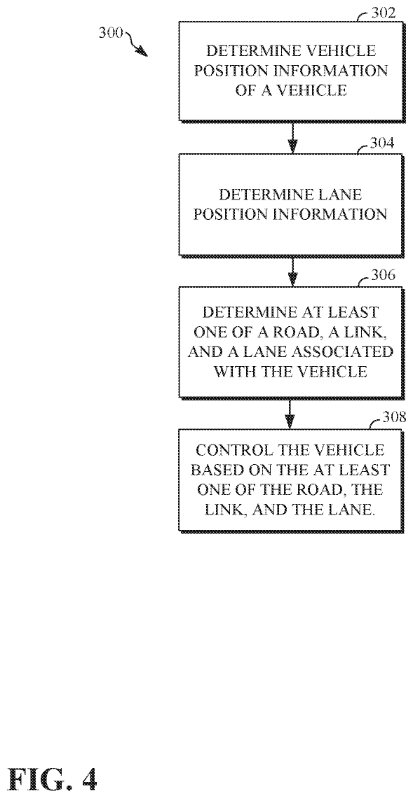

FIG. 4 generally illustrates a position lane leveling method 300 according to the principles of the present disclosure. At 302, the method 300 determines vehicle position information of a vehicle. For example, the processor 210 determines vehicle position information for the vehicle 10. At 304, the method 300 determines lane position information. For example, the processor 210 determines lane position information for the vehicle 10 based on output of a convolutional neural network. At 306, the method 300 determines at least one of a road, a link, and a lane associated with the vehicle. For example, the processor 210 determines at least one of a road, a link, and a lane of the vehicle 10 based on the vehicle position information and the lane position information. At 308, the method 300 controls the vehicle based on the at least one of the road, the link, and the lane. For example, the processor 210 controls the vehicle 10 based on the determined at least one of the road, the link, and the lane of the vehicle.

Although the above embodiments have focused on the initial source of positioning data being a global positioning system, other sources of positioning data are also permitted and can similarly be corrected or improved with the use of sensor data and CNNs and/or RCNNs as described above. Other variations and modifications of the above are possible as well.

In some embodiments, a method includes: determining vehicle position information for a vehicle; determining lane position information for the vehicle based on output of a convolutional neural network; determining at least one of a road, a link, and a lane of the vehicle based on the vehicle position information and the lane position information; and controlling the vehicle based on the determined at least one of the road, the link, and the lane of the vehicle.

In some embodiments, the vehicle position information includes at least one of Global Position System (GPS) information, Global Navigation Satellite System (GNSS) information, differentially corrected GPS information, and differentially corrected GNSS information. In some embodiments, the lane position information includes a lane number. In some embodiments, the lane position information includes a total number of lanes. In some embodiments, the lane position information includes a type of lane. In some embodiments, the lane position information includes current position within a current lane. In some embodiments, the lane position information includes an indication of drivable space within a current lane. In some embodiments, the output of the convolutional neural network is based on image data. In some embodiments, the lane position information includes current position within a current link or road. In some embodiments, the lane position information includes an indication of drivable space within a current link or road.

In some embodiments, a system includes a processor and a memory. The memory includes instructions that, when executed by the processor, cause the processor to: determine vehicle position information for a vehicle; determine lane position information for the vehicle based on output of a convolutional neural network; identify at least one of a road, a link, and a lane of the vehicle based on the vehicle position information and the lane position information; and control the vehicle based on the determined at least one of the road, the link, and the lane of the vehicle.

In some embodiments, the vehicle position information includes at least one of Global Position System (GPS) information, Global Navigation Satellite System (GNSS) information, differentially corrected GPS information, and differentially corrected GNSS information. In some embodiments, the lane position information includes a lane number. In some embodiments, the lane position information includes a total number of lanes. In some embodiments, the lane position information includes a type of lane. In some embodiments, the lane position information includes current position within a current lane. In some embodiments, the lane position information includes an indication of drivable space within a current lane. In some embodiments, the output of the convolutional neural network is based on image data. In some embodiments, the lane position information includes current position within a current link or road. In some embodiments, the lane position information includes an indication of drivable space within a current link or road.

In some embodiments, a system for vehicle position lane leveling includes a processor and a memory. The memory includes instructions that, when executed by the processor, cause the processor to: receive vehicle position information; receive output from a convolutional neural network, the output being based on image data provided to the convolutional neural network; determine lane position information for a vehicle based on the output of the convolutional neural network; identify at least one a lane associated with the vehicle based on the vehicle position information and the lane position information; and control the vehicle using the identified lane.

In some embodiments, the vehicle position information includes at least one of Global Position System (GPS) information, Global Navigation Satellite System (GNSS) information, differentially corrected GPS information, and differentially corrected GNSS information.

The above discussion is meant to be illustrative of the principles and various embodiments of the present disclosure. Numerous variations and modifications will become apparent to those skilled in the art once the above disclosure is fully appreciated.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations of the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. The term “processor” should be understood as encompassing any of the foregoing hardware, either singly or in combination. The terms “signal” and “data” are used interchangeably.

For example, one or more embodiments can include any of the following: packaged functional hardware unit designed for use with other components, a set of instructions executable by a controller (e.g., a processor executing software or firmware), processing circuitry configured to perform a particular function, and a self-contained hardware or software component that interfaces with a larger system, an application specific integrated circuit (ASIC), a Field Programmable Gate Array (FPGA), a circuit, digital logic circuit, an analog circuit, a combination of discrete circuits, gates, and other types of hardware or combination thereof, and memory that stores instructions executable by a controller to implement a feature.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

What is claimed is:

1. A method, comprising:
determining vehicle position information for a vehicle;
determining lane position information for the vehicle based on output of a convolutional neural network;
determining at least one of a road, a link, and a lane of the vehicle based on the vehicle position information and the lane position information; and
controlling the vehicle based on the determined at least one of the road, the link, and the lane of the vehicle.

2. The method of claim 1, wherein the vehicle position information includes at least one of Global Position System (GPS) information, Global Navigation Satellite System (GNSS) information, differentially corrected GPS information, and differentially corrected GNSS information.

3. The method of claim 1, wherein the lane position information includes a lane number.

4. The method of claim 1, wherein the lane position information includes a total number of lanes.

5. The method of claim 1, wherein the lane position information includes a type of lane.

6. The method of claim 1, wherein the lane position information includes current position within a current lane.

7. The method of claim 1, wherein the lane position information includes an indication of drivable space within a current lane.

8. The method of claim 1, wherein the output of the convolutional neural network is based on image data.

9. The method of claim 1, wherein the lane position information includes current position within a current link or road.

10. The method of claim 1, wherein the lane position information includes an indication of drivable space within a current link or road.

11. A system, comprising:
a processor; and
a memory including instructions that, when executed by the processor, cause the processor to:
determine vehicle position information for a vehicle;
determine lane position information for the vehicle based on output of a convolutional neural network;
identify at least one of a road, a link, and a lane of the vehicle based on the vehicle position information and the lane position information; and
control the vehicle based on the determined at least one of the road, the link, and the lane of the vehicle.

12. The system of claim 11, wherein the vehicle position information includes at least one of Global Position System (GPS) information, Global Navigation Satellite System (GNSS) information, differentially corrected GPS information, and differentially corrected GNSS information.

13. The system of claim 11, wherein the lane position information includes a lane number.

14. The system of claim 11, wherein the lane position information includes a total number of lanes.

15. The system of claim 11, wherein the lane position information includes a type of lane.

16. The system of claim 11, wherein the lane position information includes current position within a current lane.

17. The system of claim 11, wherein the lane position information includes an indication of drivable space within a current lane.

18. The system of claim 11, wherein the output of the convolutional neural network is based on image data.

19. A system for vehicle position lane leveling, the system comprising:
a processor; and
a memory including instructions that, when executed by the processor, cause the processor to:
receive vehicle position information;
receive output from a convolutional neural network, the output being based on image data provided to the convolutional neural network;
determine lane position information for a vehicle based on the output of the convolutional neural network;
identify at least one a lane associated with the vehicle based on the vehicle position information and the lane position information; and
control the vehicle using the identified lane.

20. The system of claim 19, wherein the vehicle position information includes at least one of Global Position System (GPS) information, Global Navigation Satellite System (GNSS) information, differentially corrected GPS information, and differentially corrected GNSS information.
